(19) United States
(12) Patent Application Publication
(10) Pub. No.: US 2026/0099335 A1
(43) Pub. Date: Apr. 9, 2026

(54) Neural Processing Unit Leveraged Protocol to Provide Persistency

(71) Applicant: Dell Products L.P., Round Rock, TX (US)

(72) Inventors: Thippeswamy D R, Tumkur (IN); Shekar Babu Suryanarayana, Bangalore (IN); Niyathi Shenoy K, Kasaragod (IN)

(21) Appl. No.: 18/909,125

(22) Filed: Oct. 8, 2024

(51) Int. Cl. G06F 9/4401; G06F 11/30

(52) U.S. Cl. CPC G06F 9/4416; G06F 11/3055

(57) ABSTRACT

A firmware management operation. The firmware management operation includes providing an information handling system with a distributed unified BIOS; identifying a processor environment installed on an information handling system from a plurality of processor environments, the processor environment comprising a processor architecture; and, performing a boot path persistency operation, the boot path persistency operation collecting telemetry information associated with a boot process of the information handling system.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed unified BIOS; identifying a processor environment installed on an information handling system from a plurality of processor environments, the processor environment comprising a processor architecture; and, performing a boot path persistency operation, the boot path persistency operation collecting telemetry information associated with a boot process of the information handling system.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed BIOS; identifying a processor environment installed on an information handling system from a plurality of processor environments; performing a boot path persistency operation, the boot path persistency operation collecting telemetry information associated with a boot process of the information handling system.

In another embodiment the invention relates to a computer-readable storage medium embodying computer program code, the computer program code comprising computer executable instructions configured for: providing an information handling system with a distributed BIOS; identifying a processor environment installed on an information handling system from a plurality of processor environments; performing a boot path persistency operation, the boot path persistency operation collecting telemetry information associated with a boot process of the information handling system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIGS. 5a and 5b are a simplified block diagram showing the use of a Neural Processing Unit (NPU) in the performance of one or more boot path persistency (BPP) operations; and

FIG. 6 shows the storage of persistent boot path logging data to local and cloud-based storage locations.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the invention likewise reflect an appreciation that while such additions, deletions, updates, revisions, replacements, or restorations of firmware components may be beneficial, they may also result in the IHS failing to boot properly, unexpected or continuous system reboots, variances in expected power and thermal gradients, or other unanticipated behaviors. Accordingly, changes in an IHS’s BIOS firmware component configuration may lead to system instability and diminished performance. Furthermore, such changes may likewise lead to difficulties in performing effective root cause analysis (RCA) to determine which BIOS firmware component, or the sequence of its execution, may be causing a particular boot issues.

Known approaches for facilitating the analysis and remediation of system boot process issues includes the use of boot path persistency, which as described in greater detail herein, broadly refers to the persisted maintenance of consistent and reliable logs detailing the sequence of steps performed during the boot process of a system. However, various aspects of the invention reflect an appreciation that boot path persistency, as typically implemented, may present certain challenges. For example, it can be time consuming and add delay (e.g., several seconds) to boot times.

At the same time, the boot path information collected may be sparse or not have sufficient detail, which can hinder the performance of RCA operations to remediate a particular boot process issue. Likewise, as described in greater detail herein, boot path telemetry information that is collected and stored in a cloud environment may be lost if the system fails to boot properly, further exacerbating efforts to analyze and resolve system boot issues. In particular, various aspects of the invention reflect an appreciation that system boot issues occurring in the transient phase between the performance of pre-boot operations and the performance of Operating System (OS) runtime operations may be especially difficult to analyze and resolve if associated boot path information is unavailable.

For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

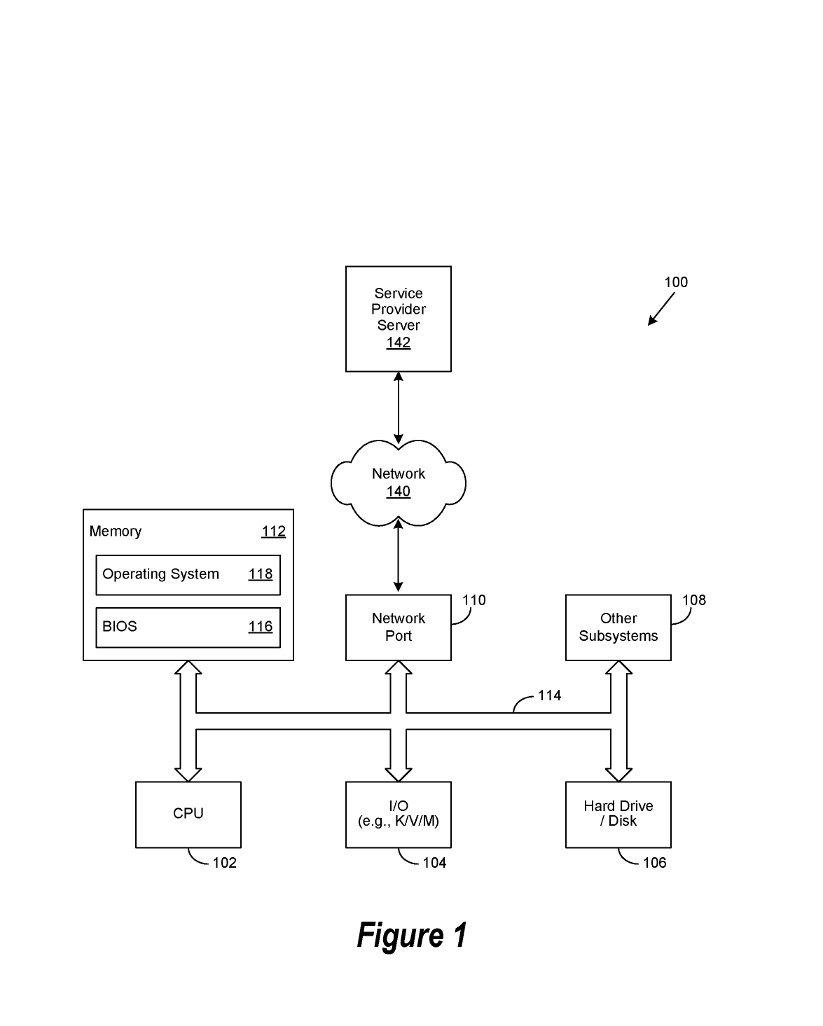

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS’s 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS’s 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS’s 100 initialization and startup within an .efi file, rather than on its associated firmware. In typical implementations, the .efi file may be stored on a special memory partition known as an EFI System Partition (ESP), which also contains the IHS’s 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein. In certain embodiments, the distributed BIOS 116 may be implemented as a distributed unified BIOS. As used herein, a distributed unified BIOS 116 broadly refers to a BIOS 116 that includes a plurality of BIOS 116 components, or a plurality of BIOS 116 variables, or a plurality of BIOS 116 storage locations, or a combination thereof, which are implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In various embodiments, the firmware management operation may be implemented to include the performance of a boot path persistency operation.

A boot path persistency (BPP) operation, as used herein, broadly refers to any function, task, procedure, or process performed, directly or indirectly, within a multi-processor operating environment, or an architecture-specific distributed firmware management platform (ASDFMP), both of which are described in greater detail herein, to collect telemetry information associated with certain boot processes and persistently store it to one or more memory storage locations, as described in greater detail herein, for use in analyzing and remediating issues related to the boot process of an associated IHS. In certain of these embodiments, the collection and persistent storage of the telemetry information may be performed in parallel with the performance of one or more boot processes of an associated IHS. In certain embodiments, the firmware management operation may be performed during operation of an IHS 100. In various embodiments, performance of the firmware management operation may result in the realization of improved operation of an IHS 100.

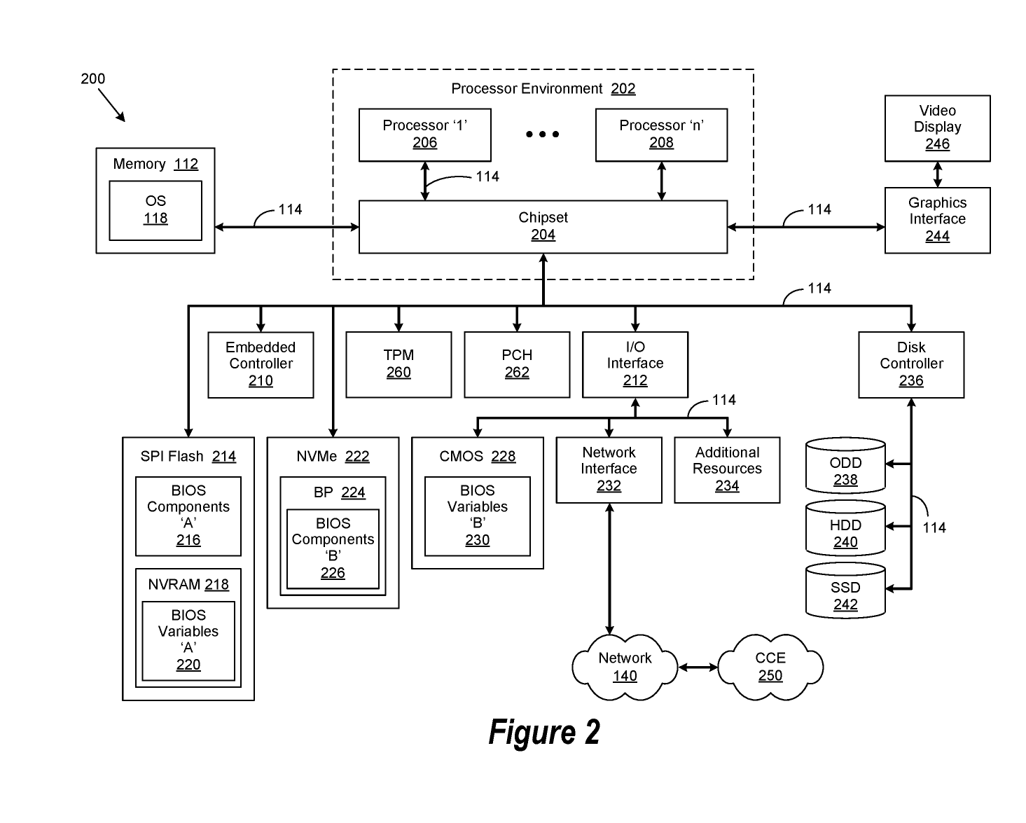

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as an information handling system (IHS), described in greater detail herein, such as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an Advanced Reduced Instruction Set Computer (RISC) Machines (ARM) type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, one or more of processors ‘1’ 206 through ‘n’ 208 may be implemented as multi-core processors. As another example, processor ‘1’ 206 may be implemented as a multi-core processor in a graphics work station, while processor ‘n’ 208 may be implemented a Graphics Processing Unit (GPU), familiar to skilled practitioners of the art. In various embodiments, one or more of the processors ‘1’ 206 through ‘n’ 208 implemented within a PE 202 may be implemented as Neural Processing Unit (NPU) type processors. In various embodiments, a Graphics Processing Unit, a Neural Processing Unit, or a combination thereof, may be implemented as separate components within the multi-processor operating environment 200.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft^{®} Windows^{®}, while processor ‘n’ 208 may be implemented to run a version of Linux^{®}.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

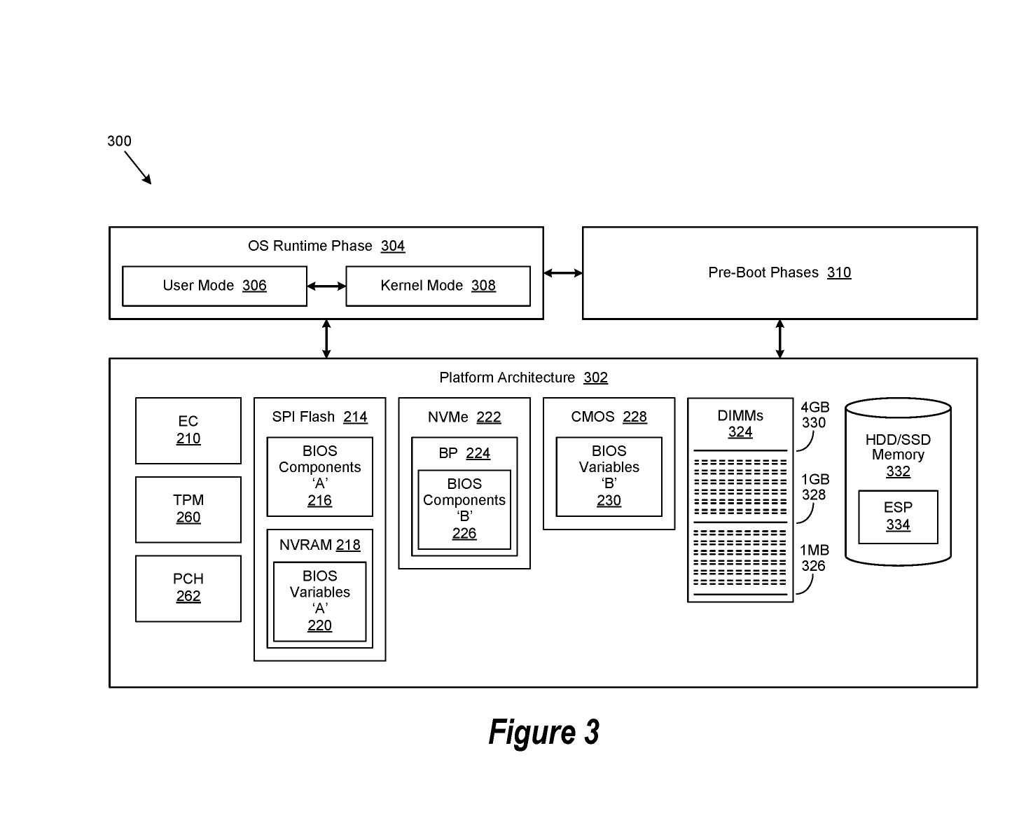

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS’s may utilize different processors (e.g., Intel^{®}, AMD^{®}, QUALCOMM^{®}, Broadcom^{®}, NVidia^{®}, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, each of which may be considered a component of an information handling system (IHS), as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel^{®} to control certain data paths and support functions used in conjunction with Intel^{®} processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel^{®}, AMD^{®}, Qualcomm^{®}, Broadcom^{®}, NVidia^{®}, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1GB 328 to 4GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS’s that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

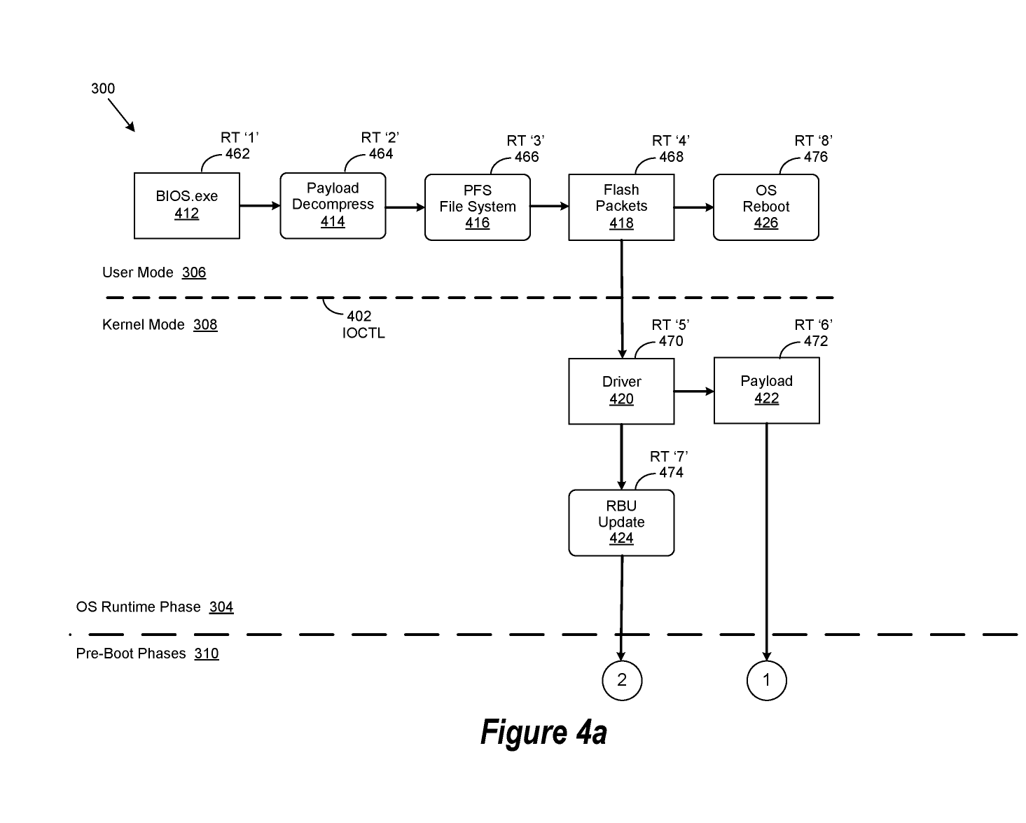

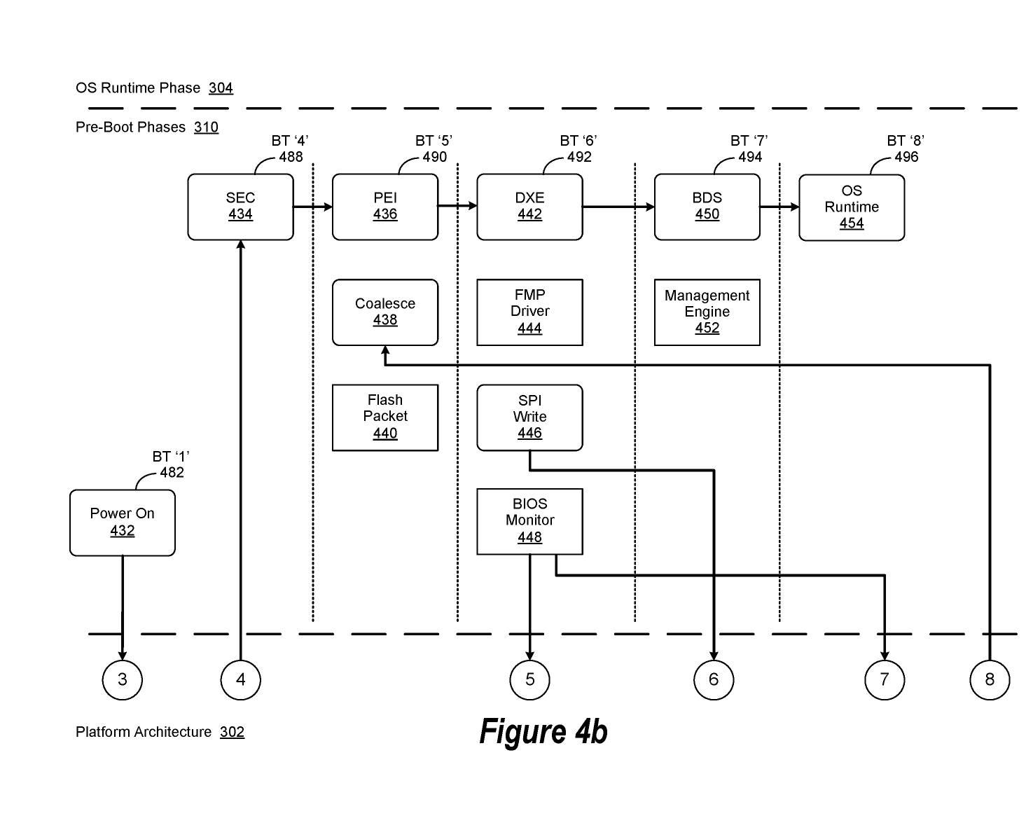

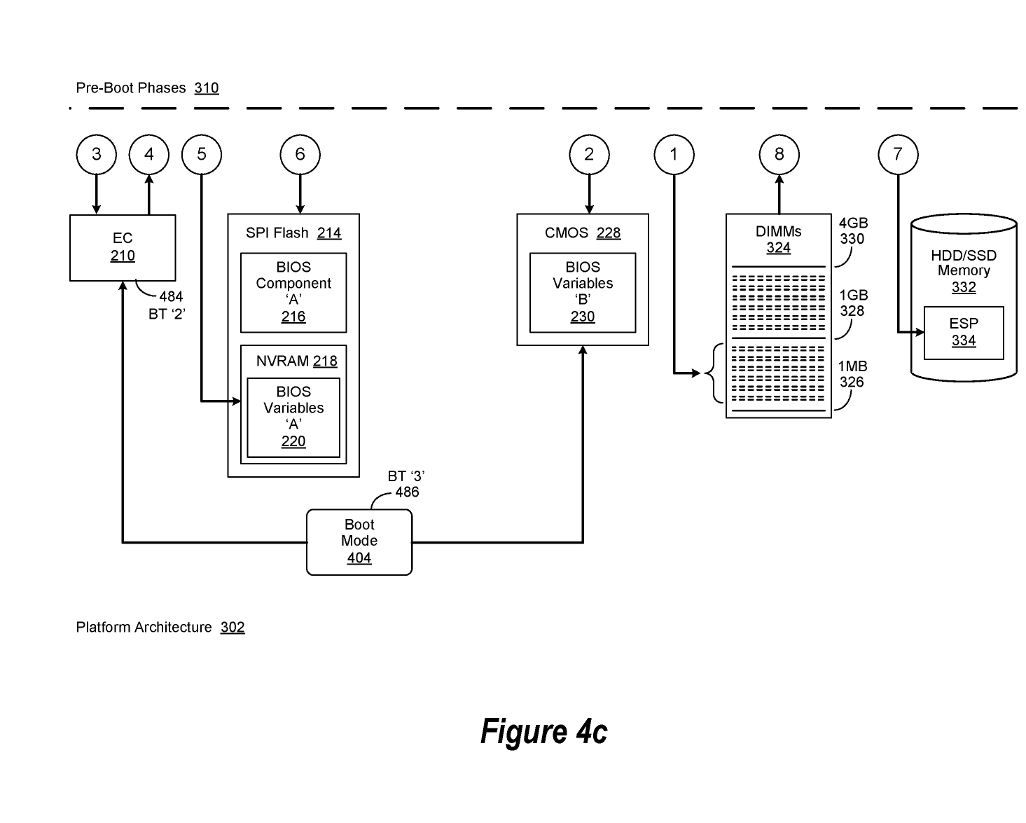

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system’s (IHS’s) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre-Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one of more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6’ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS’s processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell^{®} Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel^{®} Corporation of Santa Clara, California, may be implemented to use the selected boot device in BT step ‘8’ 496 to boot the ASDFMP 300 into an OS runtime transition 454 phase.

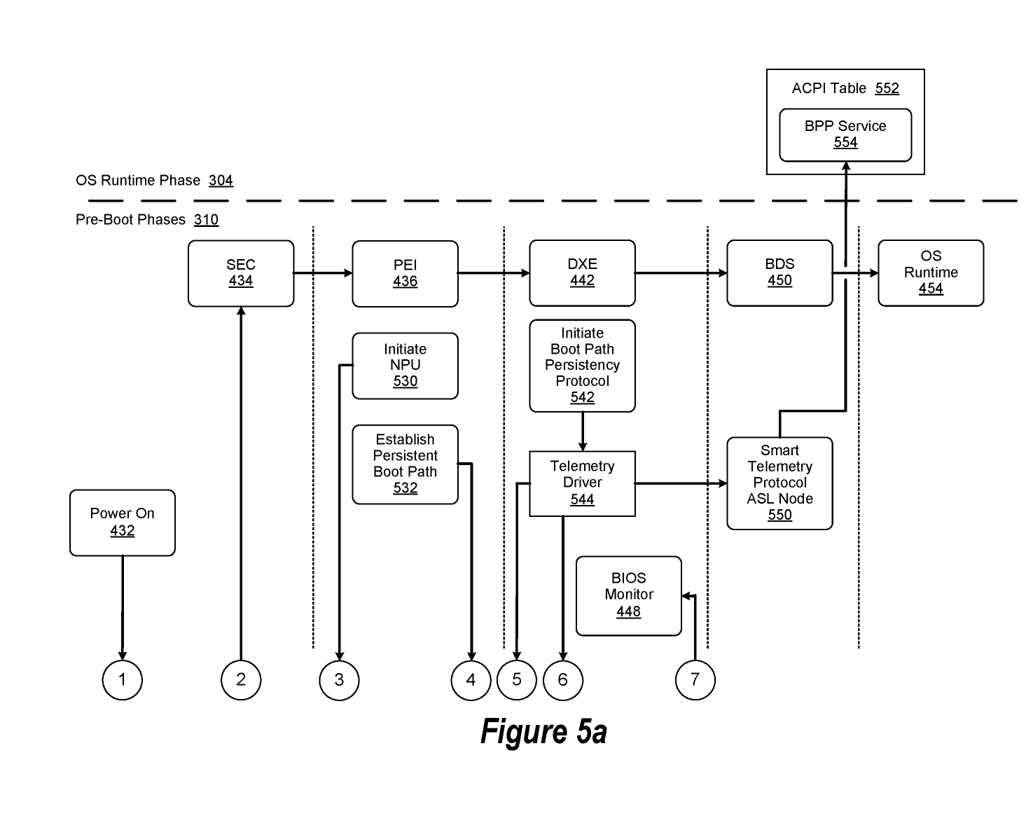

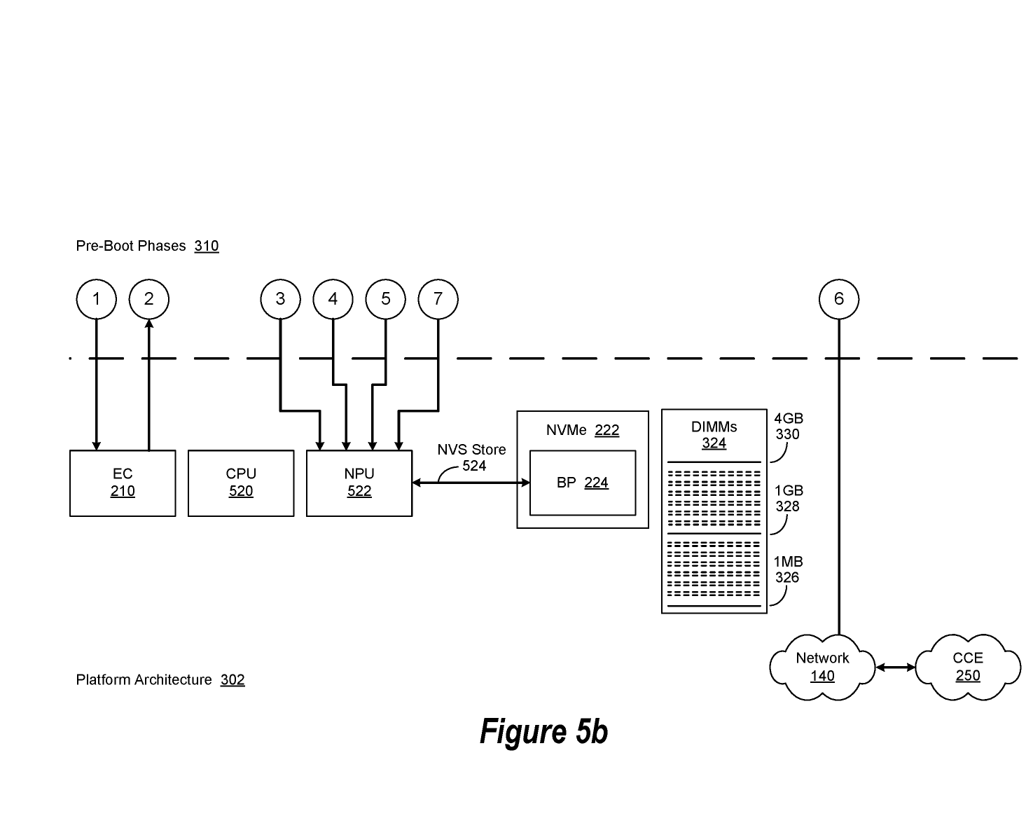

FIGS. 5a and 5b are a simplified block diagram showing the use of a Neural Processing Unit (NPU) in the performance of one or more boot path persistency (BPP) operations implemented in accordance with an embodiment of the invention. In various embodiments, an NPU may be implemented in the performance of one or more boot path persistency (BPP) operations, described in greater detail herein, to collect, maintain, and persist logging data associated with the execution of one or more Basic Input/Output System (BIOS) operations. Skilled practitioners of the art will be familiar with an NPU, which is a specialized processor chip designed to accelerate artificial intelligence (AI) and machine learning (ML) tasks.

As such, it is optimized for parallel processing and efficient execution of complex neural network computations. Likewise, various aspects of the invention reflect an appreciation that traditional Central Processing Units (CPUs) lack optimization for the parallel processing requirements of deep learning tasks, which are characterized by extensive matrix operations and nonlinear transformations. Consequently, some CPU manufacturers integrate NPUs alongside traditional CPU cores to address this limitation.

In various embodiments, the NPU may be implemented to be initialized during the Pre-Extensible Firmware Interface (EFI) Initialization (PEI) pre-boot phase, described in greater detail herein. In certain of these embodiments, one or more BPP operations may be performed to likewise initialize other information handling system (IHS) component paths that are synchronized to it. In various embodiments, such initialization of other IHS component paths may facilitate faster data processing in parallel with the IHS’s processor.

In various embodiments, one or more BPP operations may be performed to implement a telemetry driver during the Driver eXecution Environment (DXE) pre-boot phase, likewise described in greater detail herein. In various embodiments, such a telemetry driver may be used in the performance of one or more BPP operations to collect and store BIOS telemetry data logs to one or more memory storage locations. In certain of these embodiments, the memory storage location may be a boot partition (BP) within an NVMe memory device implemented within an associated IHS. Various embodiments of the invention reflect an appreciation that storing collected BIOS telemetry data logs within the BP of an NVMe memory device may provide additional security to the stored data logs and lessen the possibility of them being accessed by a malicious user.

In various embodiments, one or more BPP operations may be performed during the PEI pre-boot phase to map one or more IHS network devices to one or more associated operations performed by the NPU. In certain of these embodiments, such mappings may be used in the performance of one or more BPP operations to transfer persistent boot path logging data to a cloud computing environment (CCE), where it is stored. Various embodiments of the invention reflect an appreciation that access to such persistent boot path logging data, whether stored locally on an IHS, or remotely within a CCE, may assist in achieving more effective root cause analysis (RCA) when attempting to resolve a particular IHS boot process issue. Likewise, in various embodiments, one or more BPP operations may be performed to collect and store more BIOS monitoring information (e.g., 64KB vs. 24KB) with a modest increase in total boot time (e.g., ~ one second) than currently known approaches.

Various embodiments of the invention reflect an appreciation that the maintenance of consistent and reliable logs detailing the system files used in the process of booting an information handling system (IHS), their respective storage location, and the sequence of steps in which they are used, is conducive to achieving boot path persistency. However, various embodiments of the invention likewise reflect an appreciation that boot path persistency, as typically implemented, may present certain challenges. In particular, it can be time consuming and add delay to boot times.

For example, the Basic Input/Output System (BIOS) of an IHS is generally stored in non-volatile memory, such as Non-Volatile Random Access Memory (NVRAM) or Non-Volatile Memory express (NVMe) memory, whose respective write and access speeds are measured in milliseconds. However, certain BIOS-related files used during the boot process of an IHS may be stored in its mass storage, or in a Cloud Computing Environment (CCE), either of which may have significantly slower read and write speeds, which could add seconds to boot times.

Accordingly, various embodiments of the invention reflect an appreciation that establishing boot path persistency, and maintaining it on an ongoing basis, can be costly in terms of elapsed time. In particular, utilization of telemetry to monitor the performance, and results, of certain BIOS operations may add yet more time to the boot process of an associated IHS. Factors that may add such time include formatting data associated with an event occurring during the boot process of an IHS, which could amount to a few milliseconds for each event. Likewise, conversion of such event data to actionable telemetry may add a few milliseconds more.

Additionally, logging the resulting telemetry is typically a two-step process, each of which respectively adds additional time to the boot process. First, local logging of collected telemetry to an NVMe memory boot partition (BP) may take seconds to complete. Second, logging the same collected telemetry to a cloud computing environment (CCE) may take additional milliseconds. In both cases, the collected telemetry may be lost, in part or in whole, should the boot process fail before the logging operations are completed.

Various embodiments of the invention reflect an appreciation that no known approach currently exists for a persistent, programmable interface for runtime applications that are executed in parallel. Likewise, various aspects of the invention reflect an appreciation that current approaches for persistent BIOS event monitoring and logging generally lacks completeness in the information collected, which hinders comprehensive root cause analysis (RCA). As an example, data related to staged boot paths may not be monitored or collected, which could potentially prolong boot times. Accordingly, absence of persistent BIOS event data may result in the inability to achieve a successful RCA in the event of a boot failure.

Referring now to FIGS. 5a and 5b, an IHS may be implemented to include an OS runtime phase 304, various pre-boot phases 310, and a platform architecture 302. In various embodiments, the pre-boot phases 310 may include a security (SEC) 434 phase, a Pre-Extensible Firmware Interface (EFI) Initialization (PEI) 436 phase, a Driver eXecution Environment (DXE) 442 phase, a boot device selection (BDS) 450, and an Operating System (OS) runtime 454 transition phase, as described in greater detail herein. In various embodiments, as likewise described in greater detail herein, the platform architecture 302 may be implemented to include an embedded controller (EC) 210, one or more Central Processing Units (CPUs) 520, one or more Neural Processing Units (NPUs) 522, one or more Nonvolatile Memory Express (NVMe) 222 memory devices, one or more dual in-line memory modules (DIMMs) 324, or a combination thereof.

In various embodiments, one or more NVMe 222 memory devices may be implemented to include a boot partition (BP) 224, described in greater detail herein. In various embodiments, the platform architecture may likewise be implemented to provide access and connectivity to a network 140. In turn, the network 140 may be implemented in various embodiments to provide access and connectivity to a cloud computing environment (CCE) 250, described in greater detail herein. In various embodiments, the CCE 250 may be implemented to receive, store, manage, and provide access to certain boot path persistency data.

In various embodiments, one or more BPP operations may be initiated by the application of power 432 to the IHS, which may result in it entering an SEC 434 pre-boot 310 phase. One or more BPP operations may then be performed in various embodiments to initiate 530 one or more NPUs 522 during the PEI 436 pre-boot 310 phase. Thereafter, one or more NPUs may be used in the performance of one of more BPP operations to establish 532 a persistent boot path.

Skilled practitioners of the art will be familiar with a boot path, also known as the boot sequence or boot order, which refers to the process by which an OS is loaded and initialized on an IHS. In general, a boot path involves three components. The first is a boot partition (BP) 224, which is a designated volume on a storage device of the IHS, such as a hard drive (not shown) or a NVMe 222 memory device, that contains the system files used to initiate the OS.

The BP 224 is typically marked as active and contains a boot loader program, which is the second component of the boot path. As typically implemented, the boot loader program is used to load the OS into the main memory, such as DIMMs 324, of the IHS. The third component is the boot.ini, or Boot Configuration Data (BCD) store, which is a configuration file specifying boot options, including timeouts, default operating system, and a list of available operating systems.

As likewise used herein, a boot path definition broadly refers to the sequence of events that occur during the boot process of an associated IHS. In general, once the BIOS of the IHS has been initialized, it searches for a bootable device, such as a hard drive, a Universal Serial Bus (USB) drive, NVMe 222 memory, and so forth. Once a bootable device has been identified, the BIOS loads the boot loader program from the BP 224, which then reads the boot.ini or BCD file to determine boot options. The boot loader then presents a menu of available OS’s to the user, who then selects which one to load, which is then loaded into main memory (e.g., NVMe 222) and the boot process is completed.

In various embodiments, the boot path is persisted for use in boot process issue analysis and resolution. In various embodiments, the boot path may be persisted in an NVMe 222 memory device. In certain of these embodiments, the boot path may be persisted in an NVMe 222 device even if the boot process is not successfully completed. In various embodiments, the boot path may be persisted in a CCE 250 each time the boot process is successfully completed.

In various embodiments, the boot path may be persisted each time an associated IHS is booted. In certain of these embodiments, the boot path may be same, but may differ from one boot process instance to another of an associated IHS. In various embodiments, boot path data persisted in an NVMe 22 device, or a CCE 250, or a combination of the two, may be used as machine learning training data.

In various embodiments, one or more BPP operations may be performed to initiate a BPP protocol 542 in the DXE 442 pre-boot 310 phase. In various embodiments, one or more BPP operations, or the BPP protocol 542, or a combination of the two, may be used to initiate a telemetry driver 544. In various embodiments, the telemetry driver 544 may be used during the DXE 442 pre-boot 310 phase in the performance of one or more BPP operations to collect and store BIOS telemetry data logs to one or more memory storage locations. As used herein, a BPP protocol broadly refers to broadly refers to a standardized set of rules for formatting and processing data used in the performance of a BPP operation. In certain embodiments, the BPP protocol is used when communicating with a processor such as an NPU, an application, any of a plurality of processor components (such as the components described with respect to the multi-processor operating environment in FIG. 2), any of a plurality of peripheral components, or a combination thereof, regarding information associated with performance of a BPP operation.

In certain of these embodiments, the memory storage location may be a BP 224 within an NVMe memory 222 device implemented within an associated IHS, or a CCE 250, or a combination of the two. Various embodiments of the invention reflect an appreciation that storing collected BIOS telemetry data logs within the BP 224 of an NVMe 222 memory device may provide additional security to the stored data logs and lessen the possibility of them being accessed by a malicious user. In various embodiments, the BPP protocol 542 may be implemented use one or more NPUs 522 in the performance of one or more BPP operations to collect and persistently store BIOS telemetry data logs.

In various embodiments, a BIOS monitor 448, described in greater detail herein, may be implemented within the DXE 442 pre-boot 310 phase to monitor the boot path of the IHS. In various embodiments, the BIOS monitor 448 may be implemented to monitor the operation of one or more associated NPUs 522 during the performance of one or more BPP operations. In various embodiments, the BIOS monitor 448 may likewise be implemented to monitor the status of certain BIOS telemetry data persistently stored in the BP 224 of the NVMe 222 memory device.

In various embodiments, the one or more NPUs 522 may be implemented, individually or in combination with one another, to act as a dedicated low-power Artificial Intelligence (AI) engine. In various embodiments, one or more NPUs 522 may be implemented, individually or in combination with one another, to process BIOS telemetry information persistently stored in the BP 224 of an NV Me 222 memory device, or the CCE 250, or a combination of the two, to perform certain machine learning operations familiar to those of skill in the art. In certain of these embodiments, the BIOS telemetry information persistently stored in the BP 224 of an NV Me 222 memory device, or the CCE 250, or a combination of the two, may be used as training data to train the one or more NPUs 522 to determine the root cause of one or more boot path issues occurring during the boot process of an associated IHS.

In various embodiments, certain BIOS telemetry data collected by the telemetry driver 544 may be provided during the BDS 450 pre-boot 310 phase to a smart telemetry Advanced Configuration and Power Interface (ACPI) source language (ASL) node 550. Skilled practitioners of the art will be familiar with ASL, which is a language commonly used to make entries in an ACPI table 5552. Accordingly, the smart telemetry ASL node 550 may be implemented within various embodiments to populate the ACPI table 552 shown in FIG. 5a with certain BIOS telemetry data collected by the telemetry driver 544. In various embodiments, one or more BPP operations may be performed to provide the information stored in an ACPI table 552 in the form of one or more BPP services 554 during the OS runtime phase 304.

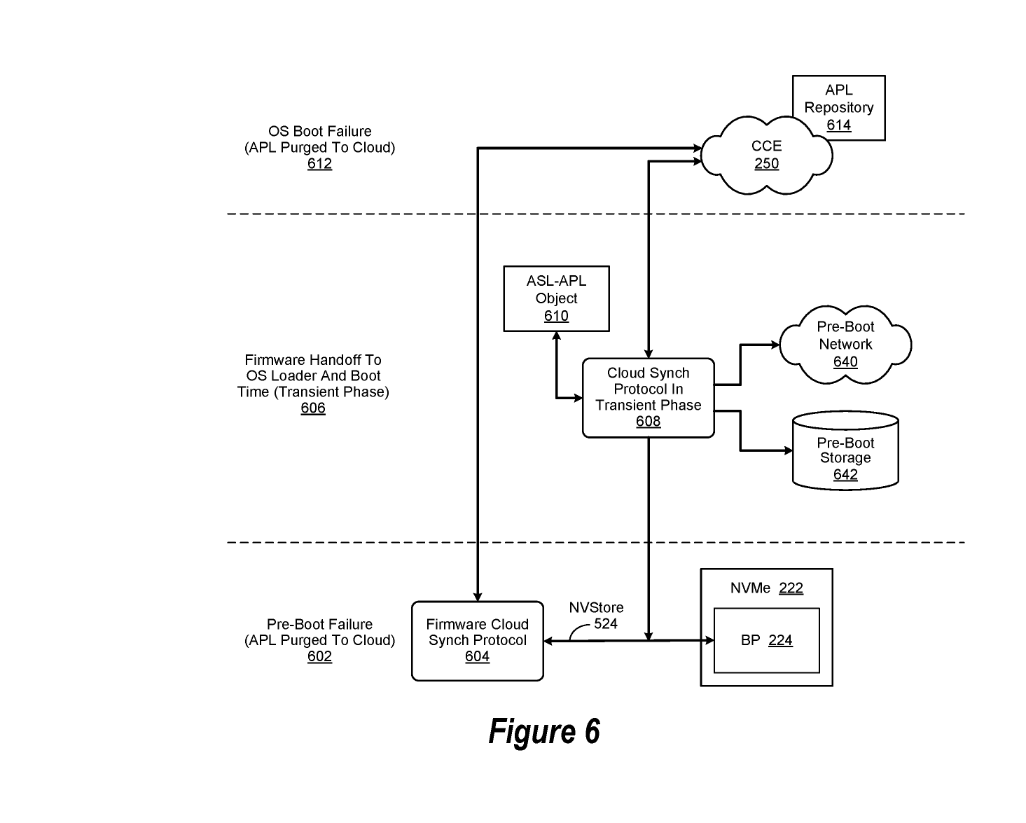

FIG. 6 shows the storage of persistent boot path logging data to local and cloud-based storage locations implemented in accordance with an embodiment of the invention. In various embodiments, one or more boot path persistency (BPP) operations may be performed to address certain Basic Input/Output System (BIOS) errors, such as transient phases during the pre-boot to operating system (OS) loader hand-off stage, including errors such as No Power-On Self-Test (NO-POST), No-Video, and OS-boot failures. In various embodiments, one or more BPP operations may be performed to actively monitor the boot path of an information handling system (IHS) and save persistent logs of associated telemetry information to the boot partition (BP) of an associated Non-Volatile Memory express (NVMe) device. In various embodiments, one or more BPP operations may be performed during the PEI pre-boot phase to map one or more IHS network devices to one or more associated operations performed by the NPU. In certain of these embodiments, such mappings may be used in the performance of one or more BPP operations to transfer persistent boot path logging data to a cloud computing environment (CCE), where it is stored.

In various embodiments, one or more BPP operations may be performed to initialize an NPU and associated local and remote memory storage locations. In certain of these embodiments, a persistent device path may be mapped between the NPU, and its associated local and remote memory storage locations, to enable faster, and more detailed, persistent boot path telemetry without increasing boot time of an associate IHS. In various embodiments, one or more BPP operations may be performed in pre-boot stages to improve monitoring of IHS boot events, reduce the time it takes to collect associated telemetry, and store it in a CCE. In certain of these embodiments, one or more BPP operations may be performed to use data compression approaches, familiar to those of skill in the art, to reduce the size of associated telemetry payloads. In various embodiments, such reduction in the size or associated telemetry payloads may result in enabling faster transmission over limited bandwidth connections, while likewise leveraging and NPU for improved error handling and attempted retransmissions. In various embodiments, the initialization of an NPU implemented within an associated IHS, and the collection of its associated boot path telemetry, may be performed in parallel with its boot process without adding additional time.

Referring now to FIG. 6, certain boot path telemetry information associated with a particular IHS may be persistently stored in the boot partition (BP) 224 of its NVMe 222 memory device, and a CCE 250, as described in greater detail herein. In various embodiments, NVStore 524 may be used to persistently store boot path telemetry information in the BP 224 of the NVMe 222 memory device. Skilled practitioners of the art will be familiar with NVStore 524, which a lightweight module that stores data by keys in a system’s internal flash memory for security purposes. For each item key, the NVStore 524 module provides the ability to store data or retrieve it. Newly added values are added to the end of the existing data, superseding the previous value that was there for the same key. In various embodiments, the NVStore 524 module may be implemented to ensure that data stored in flash memory is not compromised or erased in the event of a power failure.

In various embodiments, Advanced Persistent Logging (APL) may be used in the performance of one or more BPP operations to persistently store certain boot path telemetry information in a CCE 250 APL repository 614. Those of skill in the art will be familiar with APL, which is a logging approach that persists log data across system reboots, crashes, or other disruptions, ensuring that critical information is retained and available for analysis, troubleshooting, and resolution. As typically implemented, APL stores log data in a non-volatile storage, such as a hard drive or flash (e.g., NVMe 222) memory, to ensure that log data is not lost during system restarts or failures. APL also enables continuous logging, allowing for the capture of events over an extended period, even in the presence of high volumes of data. APL can likewise be configured to log specific types of events, set log file sizes and rotation policies, and customize log formats.

In various embodiments, a firmware cloud synchronization protocol 604 may be implemented in to synchronize persisted boot path information associated with a particular IHS that may be persistently stored in the boot partition 224 of its NVMe 222 memory device and the CCE 250 APL repository 614. However, various embodiments of the invention reflect an appreciation that such synchronization may not be able to take place in the event of a pre-boot 602 or OS 612 failure, as boot path telemetry data will be lost before it can be persistently stored in the CCE 250 APL repository 614. Accordingly, a cloud synchronization protocol 608 may be implemented in the OS transient phase, described in greater detail herein, to persistently store boot path telemetry information associated with an Advanced Configuration and Power Interface (ACPI) source language (ASL)/APL object 610 in both pre-boot network 640 and pre-boot storage 642. Accordingly, the boot path telemetry information is persistently stored in the event of a pre-boot 602 or OS 612 failure, as one or more BPP operations may be performed to hand firmware off to an OS loader at boot time during the OS transient phase 606. As used herein, an operating system transient phase (sometimes referred to as a transient system load (TSL) phase) broadly refers to a system boot phase which occurs during a transition between performance of pre-boot operations and performance of Operating System (OS) runtime operations. In certain embodiments, the transient phase occurs between a boot drive selection (BDS) phase such as BDS phase 450 and an OS runtime phase such as OS runtime phase 454. In certain embodiments, the system enters a UEFI shell or executes a UEFI application such as an OS boot loader during the operating system transient phase.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed unified BIOS;
identifying a processor environment installed on an information handling system from a plurality of processor environments, the processor environment comprising a processor architecture; and,
performing a boot path persistency operation, the boot path persistency operation collecting telemetry information associated with a boot process of the information handling system.

2. The method of claim 1, wherein:
the boot path persistency operation maintains persistency during an operating system transient phase.

3. The method of claim 1, wherein:
the boot path persistency operation interacts with a boot path persistency protocol.

4. The method of claim 3, wherein:
the boot path persistency protocol initiates a telemetry driver.

5. The method of claim 1, wherein:
the boot path persistency operation is performed during a Driver eXecution Environment (DXE) pre-boot phase of operation.

6. The method of claim 1, wherein:
the boot path persistency operation maps network devices to a Neural Processing Unit operation.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed BIOS;
identifying a processor environment installed on an information handling system from a plurality of processor environments;
performing a boot path persistency operation, the boot path persistency operation collecting telemetry information associated with a boot process of the information handling system.

8. The system of claim 7, wherein:
the boot path persistency operation maintains persistency during an operating system transient phase.

9. The system of claim 7, wherein:
the boot path persistency operation interacts with a boot path persistency protocol.

10. The system of claim 9, wherein:
the boot path persistency protocol initiates a telemetry driver.

11. The system of claim 7, wherein:
the boot path persistency operation is performed during a Driver eXecution Environment (DXE) pre-boot phase of operation.

12. The system of claim 11, wherein:
the boot path persistency operation maps network devices to a Neural Processing Unit operation.

13. A non-transitory, computer-readable storage medium embodying computer program code, the computer program code comprising computer executable instructions configured for:
providing an information handling system with a distributed BIOS;
identifying a processor environment installed on an information handling system from a plurality of processor environments;
performing a boot path persistency operation, the boot path persistency operation collecting telemetry information associated with a boot process of the information handling system.

14. The non-transitory, computer-readable storage medium of claim 13, wherein:
the boot path persistency operation maintains persistency during an operating system transient phase.

15. The non-transitory, computer-readable storage medium of claim 13, wherein:
the boot path persistency operation interacts with a boot path persistency protocol.

16. The non-transitory, computer-readable storage medium of claim 15, wherein:
the boot path persistency protocol initiates a telemetry driver.

17. The non-transitory, computer-readable storage medium of claim 13, wherein:
the boot path persistency operation is performed during a Driver eXecution Environment (DXE) pre-boot phase of operation.

18. The non-transitory, computer-readable storage medium of claim 13, wherein:
the boot path persistency operation maps network devices to a Neural Processing Unit operation.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
